(19) United States
(12) Patent Application Publication
(10) Pub. No.: US 2013/0276968 A1
(43) Pub. Date: Oct. 24, 2013

(54) PROCESS FOR FORMING AN AIRLESS SOLID CORE TIRE MOUNTED ONTO A WHEEL

(71) Applicant: James G. Moore, Boulder City, NV (US)

(72) Inventor: James G. Moore, Boulder City, NV (US)

(21) Appl. No.: 13/452,901

(22) Filed: Apr. 22, 2012

(51) Int. Cl. B29C 69/00

(52) U.S. Cl. 156/245

(57) ABSTRACT

A process for forming a solid polyurethane an airless solid core tire with a wheel rim bonded thereto where the tire bonding takes place during the tire casting or molding process where a wheel rim area, that includes a circumferential trough, is etched, treated with a primer and, after drying, receives an adhesive coating applied thereto, and the wheel is positioned in a mold to receive a mixture of polyurethane materials passed into the mold to form the airless solid core tire that is permanently bonded onto the wheel rim.

### BACKGROUND OF INVENTION

1. Field of the Invention

This invention pertains to a process for the formation of an airless solid core tire from an polyurethane material that is permanently bonded onto a wheel rim in a single spin casting, vacuum forming, or other casting method, forming a tire and wheel combination that is suitable for limited use as a light vehicle tire.

2. Prior Art

An airless solid core tire that is like that utilized in the tire and wheel combination of the invention has been mounted onto its separate rim after tire manufacture. Such arrangement, however, has not provided a secure bond between the tire and wheel rim and, when such tire has been subjected to strong side loads, as when a vehicle mounting the tire is turned sharply, the tire rim mounting surface has tended to separate from the wheel rim, sometimes tearing the airless solid core tire off of the wheel rim. The invention, recognizes this potential tire and wheel separation, and provides for permanently and securely bonding the tire rim mounting surface to the wheel rim. Which permanent bonding takes place in the casting or molding process where an etched wheel rim surface as will connect to the tire rim mounting surface is coated with a select primer and adhesive and positioned in the hub area of the tire mold. An airless solid core tire is then cast or otherwise formed onto the wheel rim, with, after tire curing on the wheel, the tire and wheel are permanently attached together.

The preferred tire is formed from a select polyurethane material utilized in a spin casting, vacuum forming, or other casting method. In which tire forming operation, a wheel rim receives and bonds to a tire rim attachment area, permanently attaching the formed tire onto the wheel. The tire and wheel combination so formed can then be subjected to side loads without separation that would cause a cast, vacuum formed, or otherwise formed tire that is separately mounted onto a wheel rim to separate.

### SUMMARY OF THE INVENTION

It is a principal object of the present invention to provide a process for forming an airless solid core tire manufactured from a polyurethane material that is permanently mounted onto a wheel rim in the tire formation process, which tire may have like equal spaced cavities formed in opposite side walls of the tire for reducing tire weight and includes a center wall located between the cavities extending from the tire rim to tire tread.

Another object of the present invention is to provide a process for forming an airless solid core tire where the tire is formed from a polyurethane material by casting or molding methods onto a wheel such that the tire rim area is permanently bonded to the wheel rim.

Still another object of the present invention is to provide a process for treating the wheel rim and applying a primer and adhesive between the rim edges prior to its positioning in a tire mold to condition the wheel rim to bond or weld to a polyurethane tire material that the tire is molded or cast from in the tire formation process.

Still another object of the present invention is to provide steps in a process for treating the wheel rim to receive and bond to a molded or cast tire that include etching and heat treating the wheel rim, application of a selected primer and application of a selected adhesive to the rim area of a wheel that is mounted in a mold that then receives the polyurethane material, forming the tire bonded to the wheel rim.

The present invention is in a process for forming an airless solid core tire that is bonded onto a wheel rim in a tire casting or molding operation. A practice of the process includes an etching of the wheel rim and coating of that wheel rim with a selected primer within an hour of the wheel rim etching. Whereafter, a selected adhesive is applied over the primer coated wheel rim. The wheel rim that has been etched and received a coating of a primer and an adhesive is then baked in an oven for approximately three hours at a selected temperature and wheel is then positioned in a mold for casting or molding a airless solid core tire utilizing a polyurethane material. A polyurethane tire is then cast or molded onto the wheel rim in a single operation and, after curing, the mold is opened and the tire and wheel combination is removed.

Where a spin casting method is used to cast the tire onto the wheel, after the wheel that has been etched and has had its rim coated first with a primer followed by an application of an adhesive and after baking that wheel, it is positioned in the spin casting mold and the mold is closed. The mold is spun up to a desired RPM and the polyurethane material is fed into the mold through a nozzle that is installed through the wheel rim, with the polyurethane material flowing outwardly to the tire tread area and filling back to the wheel rim. With the mold filled, the spinning is stopped and the polyurethane material is allowed to cure. After curing, the mold is opened and the wheel whereto the airless solid core tire is bonded is removed.

In practice, a tire and wheel combination formed by a practice of the process of the invention provides a bond at the connection of the tire rim area and wheel rim that will not separate when even a very significant side load is applied to the tire. Therefore, the tire as can be fixed to the wheel can be one that may tend to bend when subject to side forces, such as an airless solid core tire having spaced cavities formed in the tire sides across from a solid center section for reduction of tire weight. Though, of course, the process of the invention for bonding or welding an airless solid core tire rim area to a wheel rim in the tire formation process is also suitable for forming an airless solid core tire that does not include cavities in its side walls.

### DESCRIPTION OF THE DRAWINGS

The invention may take physical form in certain parts and arrangement of parts, and a preferred embodiment of which will be described in detail in this specification and illustrated in the accompanying drawings which form a part hereof:

FIG. 1 shows a top plan perspective view of an airless solid core tire and wheel combination formed by a practice of the process of the invention;

FIG. 2A is a view like that of FIG. 1 only showing the airless solid core tire without the wheel and showing the airless solid core tire rim area;

FIG. 2B shows the wheel separated from the airless solid core tire of FIG. 2A, and shows a first brush applying a coating of the wheel rim with a primer for practicing the process of the invention;

FIG. 3 shows an exploded profile perspective view of an open spin casting mold wherein the wheel of FIG. 2B is positioned and shows a second brush applying a coating of an adhesive onto the wheel rim area prior to mold closing and spin casting to form an airless solid core tire bonded onto the wheel rim; and

FIG. 4 shows a block flow schematic of the steps of the process of the invention for forming the airless solid core tire bonded to the wheel of FIG. 1.

### DETAILED DESCRIPTION

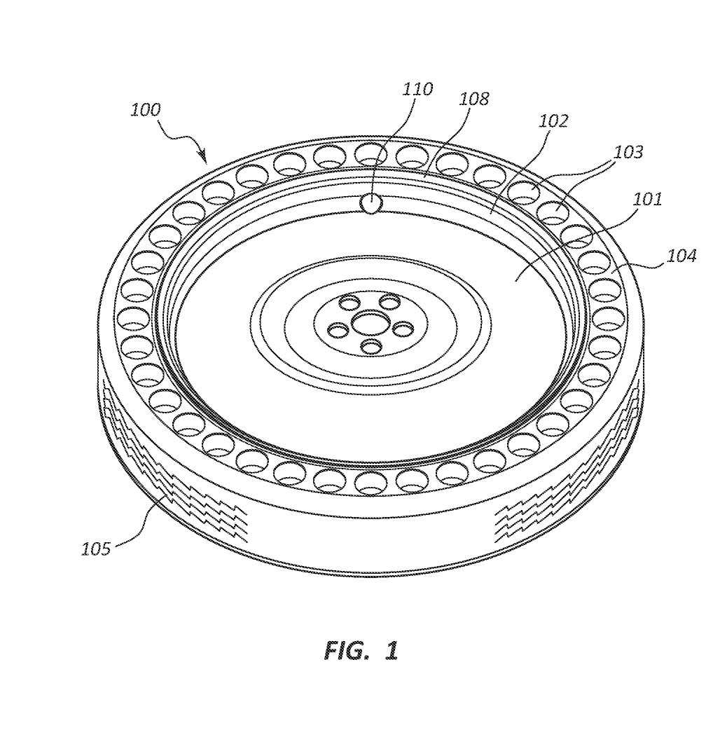

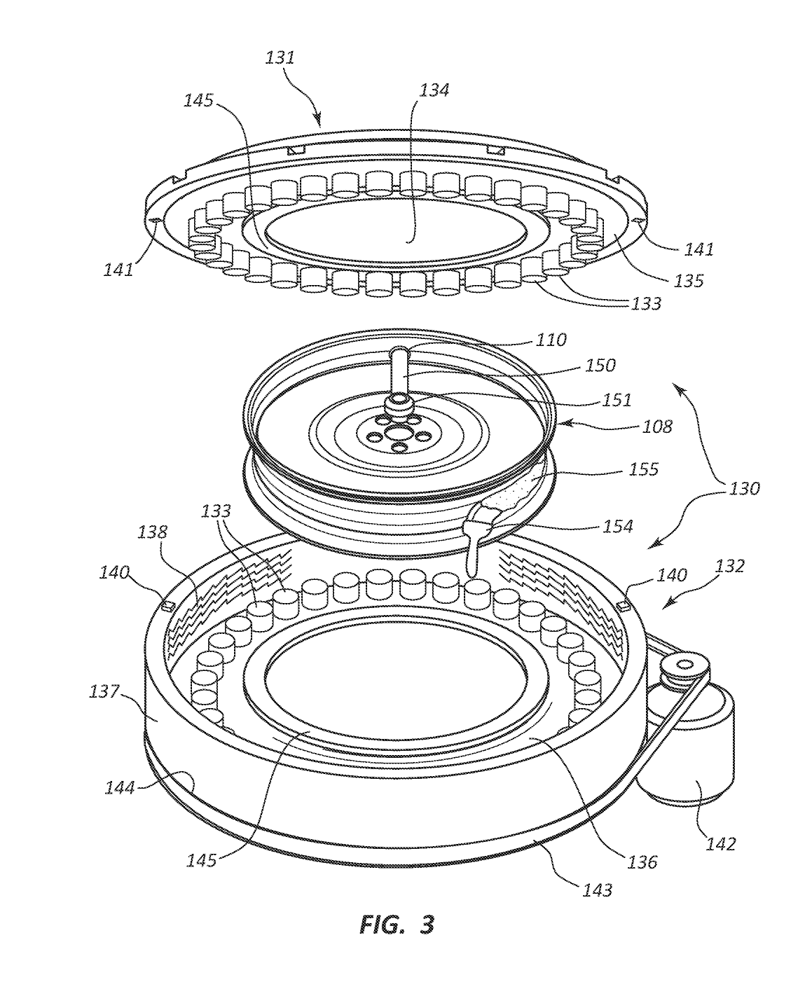

The present invention is in a process for forming an airless solid core polyurethane tire that can be a light duty automobile or truck tire or spare tire, that is permanently bonded onto a wheel rim in the tire molding or casting process. FIG. 1 shows a practice of the process of the invention for forming a tire 101 bonded to a wheel 102 rim 108, forming the tire and wheel combination 100, in a tire molding or casting process. Which molding or casting process includes, for a selected polyurethane material, mixing the polyurethane material constituents and injecting the mixed materials into a mold for casting or molding the tire and wheel combination 100. An example of such a mold is shown in FIG. 3 as mold 130, as discussed in detail below.

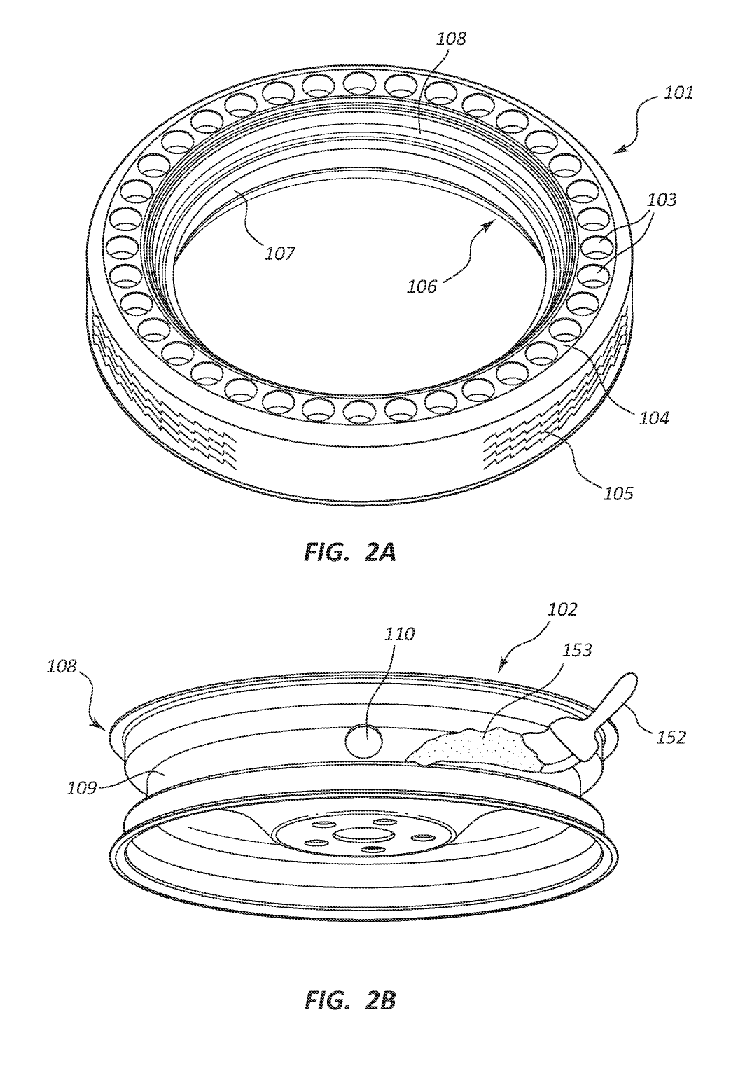

The process of the invention is suitable for forming an airless solid core spare or light duty tire 101, and that tire may be one with spaced cavities 103 formed in tire side walls 104 that are off set across the tire side walls 104 and are separated by a center wall that extends from the tire tread 105 to a tire rim area 106. Which spaced cavities 103 can be any appropriate shape, within the scope of this disclosure, and are to provide for a less weight of tire than one that is a solid tire. Such lesser weight tire will, however, exhibit more lateral flexure than a solid side wall tire when such tire experiences side loads and, dependant upon the intensity of the such side loads, that flexure could, for a conventional arrangement of a tire that has been fitted over a wheel rim, cause the tire rim area to separate from the wheel rim 108, with the tire then folding upon itself. With a practice of the process of the invention, the center of the tire rim area is cast so as to have a shoulder 107, as shown in FIG. 2A, located within a center trough 109 of wheel 102 rim 108, as shown in FIG. 2B, and which shoulder 107 prohibits removal of the tire 100 off from the wheel 101. Further, in a practice of the process of the invention, the tire rim area 106 is bonded or welded to the tire rim 108 by, prior to a casting or molding of the tire, utilizing an application of an adhesive across the wheel rim 108 surface, as illustrated by brush 152 applying an adhesive coating 153 to the rim between edges 101a thereof, as shown in FIG. 3. In practice, with the tire 100 rim area 106 bonded by a cured adhesive onto the wheel rim 108, the tire cannot shift on, or lift off, the wheel 101 rim 108, even under intensive side loading.

Where the process of the invention is suitable for practice with molding, casting or even vacuum forming methods, for this disclosure, it is shown in FIG. 3 as practiced in a spin casting apparatus 130. Shown therein, the spin casting apparatus 130, includes upper and lower mold halves 131 and 132, respectively. With the upper mold half 131 shown as a plate that is open across a center hub area 134 and has a side wall 135 that equal spaced piers 133 extend therefrom. Which piers, in the molding or casting process, form the cavities 103 in the tire side wall 104 of FIGS. 1 and 2A. The lower mold half 132, like the upper mold half, includes a side wall 136 that spaced piers 133 extend from that form the tire cavities 103. Which lower mold half 132, however, is shown as closed across its hub area, and includes an upstanding wall 137 that extends at a right angle upwardly from around the side wall 136 outer circumference, forming a cylinder that has a tire tread 138 embossed therein that form the tire 101 tread 105. Spaced lugs 140 and lug holes 141 are provided, respectively, in the top edge of the wall 137 and back from the outer edge of the upper mold half 131. The respective lugs 140 and lug holes 142 provide for alignment of the mold 130 halves, securing the mold halves together for turning by operation of a motor 142. The motor 142 turns a drive belt 143 that is fitted into a track 144 that is formed around the mold lower half 137, adjacent to its bottom edge, to spin mold 130.

For forming the tire 101 on the wheel 102, the wheel 102 is positioned on the lower mold half 132 hub center area that is shown as closed, but may be open thereacross, within the scope of this disclosure. Ring seals 145 are fitted to the opposite inner surface of both the upper and lower mold halves that engage the wheel rim 108 outer edges, sealing thereto, and the wheel 108 is positioned onto the ring seals 145 when the mold 130 is closed before casting. The ring seals 145 seal the rim 108 edges against a flow of polyurethane materials thereacross. A material feed pipe 150 is connected through a pivot to turn freely with the turning mold 130, and will feed a mixture of polyurethane constituents therethrough that pass out through a nozzle end 151 that is attached to the wheel rim gate hole 110, shown also in FIGS. 1 and 2B. So arranged, the feed pipe 150 and nozzle end 151 turn with the mold as the polyurethane mixture travels through the wheel rim gate hole 110, and pass into the mold cavity. Which polyurethane materials, in the spin casting process, travel outwardly, filling the mold cavity to the mold tread 138, and back fill to the wheel rim, forming the tire and wheel combination 100 of FIG. 1. In which mold cavity filling, the upper and lower mold halves 131 and 132 ring seals 145 contain the flow into the mold 130 cavity.

The above set out apparatus and its functioning is an example of a spin casting apparatus and its use for spin casting the tire and wheel combination 100 utilizing the process of the invention. It should, however, be understood that the process of the invention can utilize an injection molding apparatus where the mold is not spun; can involve a vacuum forming apparatus, or the like, to form the tire and wheel combination; within the scope of a practice of the process of the invention.

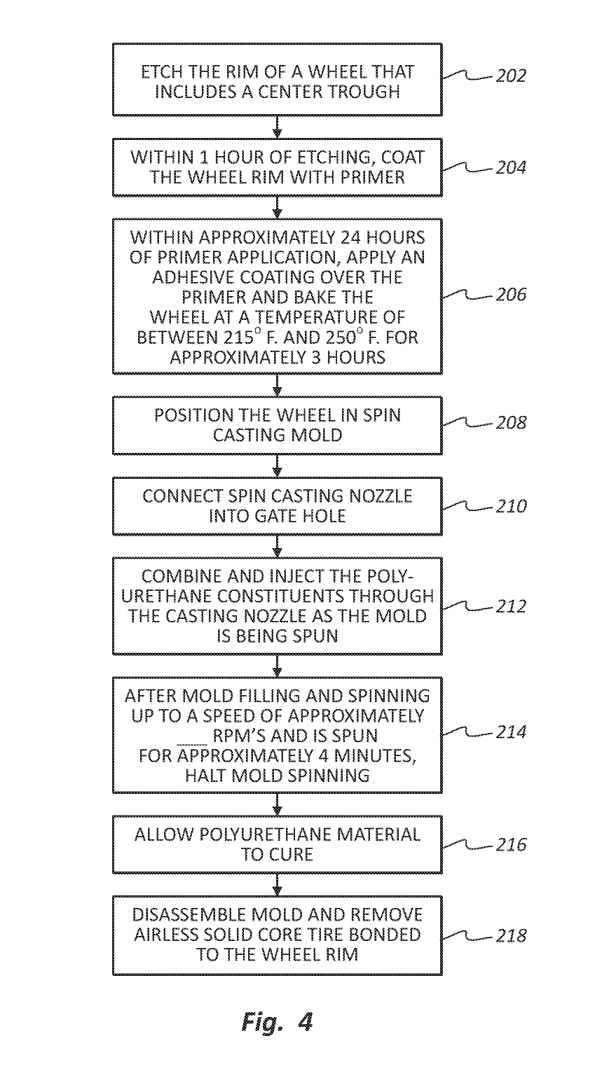

For a practice of the process of the invention to form the tire 100 on wheel 101, as illustrated in FIG. 4, the steps include: etching the rim of wheel 101 that includes a center trough, block 202; within an hour of that etching applying a primer coating to the wheel rim, block 204, illustrated as a brush 152 applying a coating of a primer 153 in FIG. 2B; within twenty four hours of primer coating application, applying a coating of an adhesive over the primer coating, illustrated by a brush 154 applying an adhesive coating 155 to the wheel rim in FIG. 3, and baking the wheel 102 at a temperature of between two hundred fifteen degrees F. and two hundred fifty degrees F. for approximately three hours, block 206; positioning the wheel 101 in a mold, block 208; passing a mixture of polyurethane constituents into the mold, filling that cavity between the mold tread 138 and seals 145, illustrated in FIG. 3, blocks 210 through 214; after allowing the mold 130 to cool, block 216; disassembling the mold and removing the airless solid core tire 101 that is bonded to the wheel 102, forming the tire and wheel combination 100. For a use of the spin casting mold 130 that is illustrated in FIG. 3 used in a practice of the present process for forming the tire and wheel combination 100, the steps illustrated by blocks 210 through 214 additionally include: connection of a casting nozzle into a gate hole formed through the wheel rim, block 210; and injecting a mixture of polyurethane materials therethrough into the mold cavity as the mold is spun, block 212; and, after mold filling and spinning for approximately four minutes, halting mold spinning, block 214.

It should be understood that, for a practice of the process of the invention where another molding, casting or vacuum forming method is employed, the steps of blocks 210 through 214 will be modified to accommodate such apparatus, within the scope of this disclosure.

In a practice of the process of the invention a preferred primer material for coating the wheel rim area 108 is marketed as Chemlok® 219, and a preferred adhesive is marketed as Chemlok® 213, both manufactured and sold by Lord Chemicals. In practice, the polyurethane material constituents as have been utilized are an isocyanate and a polyol that are combined together and are directed into the molding apparatus wherein the tire and wheel combination is formed.

A preferred embodiment of the practice of the invention for forming a solid tire and wheel combination has been shown and described above. It will, however, be apparent to one knowledgeable or skilled in the art that the above described process may incorporate changes and modifications without departing from the general scope of this invention. Which invention therefore is intended to include all such modifications and alterations in so far as they come within the scope of the appended claims and/or a reasonable equivalence thereof.

I claim:

1. A process for forming an airless solid core polyurethane tire bonded onto a wheel in the tire formation process consisting of the steps of, etching a wheel area of a rim that includes a center trough formed around the rim center; coating the rim etched area with an adhesive primer; within twenty four hours of application of said adhesive primer, apply a coating of an adhesive over said adhesive primer coated wheel rim area; bake said wheel with applied adhesive primer and adhesive in an oven at a temperature of between two hundred fifteen and two hundred fifty degrees F.; position said baked wheel in a tire mold; close said mold; direct a flow of a mixture of polyurethane materials into, to fill, said mold; allow said polyurethane materials to cure; and open said mold and remove said wheel that an airless solid core polyurethane tire is bonded to said wheel rim area.

2. The process as recited in claim 1, wherein the adhesive primer is applied to the etched wheel rim area within approximately one hour from said wheel etching.

3. The process as recited in claim 1, wherein the etched wheel with a rim area that a primer and adhesive has been applied to is baked for approximately three hours.

4. The process as recited in claim 1, wherein the mold is a spin casting mold.

5. The process as recited in claim 4, wherein the flow of the mixture of polyurethane materials is directed through an nozzle end of a feed line that is journaled to turn with said mold, and which said nozzle end is secured through a gate hole formed through the wheel rim trough, to pass said into and fill said mold.

6. The process as recited in claim 5, wherein the polyurethane materials are injected through the nozzle end as the mold is spun up to a speed of approximately from one to four hundred revolutions per minute, and is spun for approximately four minutes, whereafter spinning is discontinued.

7. The process as recited in claim 6, wherein, after the polyurethane materials are cured, the mold is opened and a finished airless polyurethane tire bonded to the wheel is removed.

8. The process as recited in claim 1, wherein the mold is constructed to form spaced cavities in the airless solid core tire side walls that are separated by a center wall.

9. The process as recited in claim 1, wherein the preferred adhesive primer is a liquid primer identified as Chemlok 219© and the adhesive is an adhesive identified as Chemlok 213© that are both manufactured by Lord Chemical Corporation.
